(19) United States
(12) Patent Application Publication
(10) Pub. No.: US 2009/0164311 A1
(43) Pub. Date: Jun. 25, 2009

(54) Human resource management system

(75) Inventor: Roderic C. Deyo, Redmond, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/002,827

(22) Filed: Dec. 19, 2007

(51) Int. Cl. G06Q 10/00

(52) U.S. Cl. 705/11

(57) ABSTRACT

A human resources management system that aids an organization select job applicants from a pool of job applicants. The system predicts performance of applicants based on job application information using a predictor developed by comparing information from prior applicants to information about the performance of those applicants. Performance may include on-the-job performance for applicants that have previously been hired or may include performance of selected applicants at interviews. The system may include a component to identify text in a resume or other job application material that acts as a feature for information useful in predicting performance. The system may also include a component that develops and updates a predictor based on actual performance of prior applicants.

### BACKGROUND

Organizations that employ large numbers of people likely use a human resources function that, among other tasks, receives applications from interested job seekers. Typically, a large part of job applications are in the form of resumes that contain a summary or listing of relevant job experiences and education that highlight reasons why a potential recruit should be hired. In this regard, an important role of the human resources function is to choose from a pool of applicants which ones to interview and eventually, which ones to hire. The manner in which resumes are sorted through and first decisions are made regarding whether or not to invite an applicant for an interview has largely been a manual process.

### SUMMARY OF INVENTION

In aspects of the present invention, a system is implemented where relevant data from applicant information received from job applicants are extracted for quick and accurate decisions as to which applicants from an applicant pool will be invited for an interview. In this respect, a predictor is developed and used to predict future performance of job applicants based on applicant information. The predictor may be frequently updated based on existing employee data and/or other relevant information about prior applicants. As part of updating the predictor, particular items or groups or items may be identified in an application or resume that are positive indicators that correlate with future employment success.

An applicant database may be provided containing applicant information such as resumes or applications received from job applicants. In addition, historical performance data of previous applicants and/or employees may be accessed from a historical database for use in developing an appropriate predictor and in identifying items of applicant information to be used as inputs to the predictor. In developing a suitable predictor, a plurality of predictors may initially be used, each predictor employing a particular machine learning algorithm. In this regard, the predictors may develop the ability to predict future performance of job applicants based on values of one or more items of applicant information, using the historical database as a reference point. In addition, an independent validation set may be used to score each of the predictors from which one or more predictors may be chosen to evaluate the existing applicant database.

Once an appropriate predictor is chosen, the selected predictor may be used in choosing individual applicants to be invited for interview based on indicators of positive performance. Applicants who are selected to interview and are actually interviewed may be evaluated by any suitable method. In this regard, the evaluation may be incorporated into the historical database for future reference or future use in updating the predictor. If applicants are hired and spend time working as employees, performance data may also be incorporated into the historical database.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is schematic representation of system for processing applications and selecting applicants to interview according to some embodiments of the invention;

FIG. 2 is a flowchart of a process in which features and predictors are selected based on applicant performance according to some embodiments of the invention;

FIG. 3 is a flowchart of a process where values of features are extracted from items on resumes based on historical performance data according to some embodiments of the invention;

FIG. 4 is a schematic representation of a system for selecting an appropriate predictor of future performance from resumes according to a performance data pool and a validation set according to some embodiments of the invention; and

FIG. 5 is a flowchart of a process in which applicants are chosen to interview based on predictor selection from updated historical data according to some embodiments of the invention.

### DETAILED DESCRIPTION

The inventors have appreciated that in any organization where a significant amount of hiring occurs, the process of selecting potential job applicants to interview may have elements that are time consuming, imprecise, and/or inaccurate. In particular, when organizations are relatively large, the pool of job applicants, with each job applicant having a corresponding resume or other applicant information, may typically be quite large. A substantial amount of time may be devoted by hiring staff to evaluating the considerable number of resumes. Ideally, each job applicant will be thoroughly evaluated, with all aspects of the application and resumes corresponding to each job applicant being taken into account.

In addition, there are substantial costs not only in interviewing and hiring those who ultimately turn out to be unsuitable for the job, but there is also an opportunity cost in not selecting people for interviews and hires that in the end, would turn out to be more successful. As a result, even slight improvements in efficiently and accurately predicting hiring success may provide significant cost savings.

The applicants have appreciated that organizations frequently maintain data that, through appropriate data processing, could greatly improve the efficiency and accuracy with which human resources functions, such as selecting applicants to interview, may be performed. In various aspects presented herein, the process of evaluating resumes or other job applicant information may be made substantially more efficient and objective through an automated system where resumes may be entered in, and analyzed by a predictor constructed with historical performance data such as data that organizations may otherwise maintain in its employees or prior applicants interviewed. With a predictor constructed in this fashion, job applicants may be selected for interviews based on the qualities that have been present in their resumes that have been determined to be good indicators of future job success.

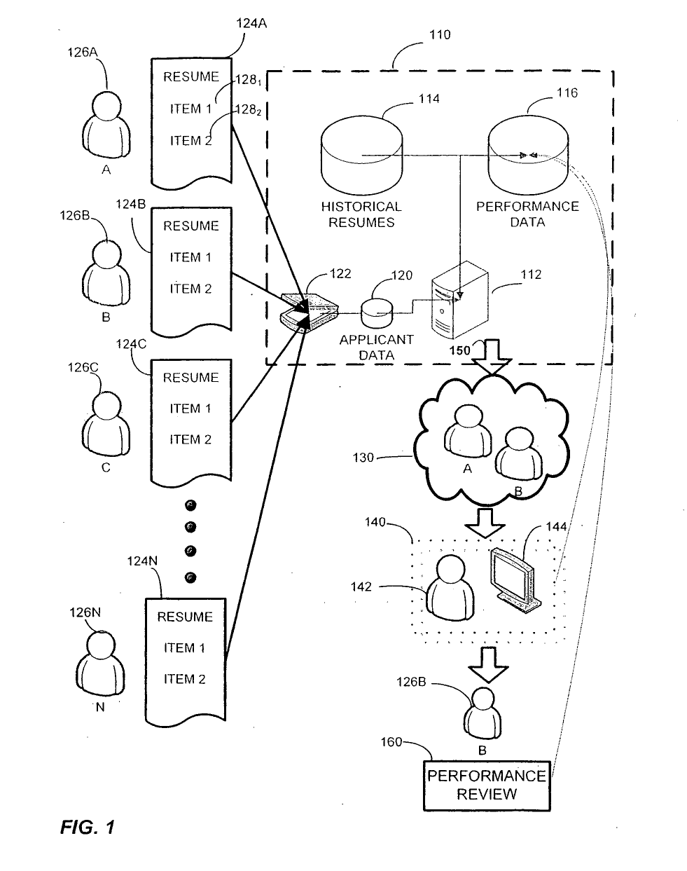

In accordance with aspects of the present invention, FIG. 1 illustrates a process that may be performed by a human resources function in a company or enterprise. In general, applications corresponding to job applicants 126A, . . . , 126N submit corresponding applicant information that may be relevant to the type of position that they are applying for at a company. In some embodiments, applicants 126A, . . . , 126N may submit applicant information 124A, . . . , 124N that contain various items 128₁, 128₂ that communicate their experience, educational background, specific skills/knowledge, and/or any other information that pertains to a position that the company may be interested in hiring for. As shown in FIG. 1, resumes 124A, . . . , 124N are given as an example of submitted applicant information. However, it should be understood that applicant information corresponding to job applicants may come in any suitable form, such as for example, written text, audio, and/or video. In addition, it is also possible that applicants themselves do not submit applicant information, but rather a third party, or recruiting personnel that serve as part of the human resources function provide the information.

The pool of applicants 126A, . . . , 126N and corresponding resumes 124A, . . . , 124N submitted may be any finite number or could be an endless stream, each of the resumes 124A, . . . , 124N being inputted through any suitable method or device 122, and subsequently stored into an applicant database 120. In various embodiments, applicant information may be communicated in any appropriate form, not limited only to resumes 124A, . . . , 124N, but could be, for example, but not limited to, previous knowledge of the applicant, a third party interview, and/or any other suitably supplemental method. It should also be understood that the way in which applicant information may be entered into an applicant database 120 may be in any appropriate way, not limited to a scanner 122 as depicted in FIG. 1, but may be through downloading electronic documents, e-mail, text input through a keyboard, mouse, or any other device, audio input, and/or any appropriate input method.

In some embodiments, an applicant database may be provided to consolidate and organize job applicant information. Information corresponding to each job applicant may vary widely as each job applicant may come from a large range of different skills/knowledge, experiences, and educational backgrounds. Resumes are typically available for each job applicant, providing information such as, for example, schools attended and/or graduated from, department, major, grade point average (GPA), awarded degrees, standardized test scores, work experience (internships, jobs, etc.), professional certifications and awards, relevant skills/knowledge, interests, activities, leadership potential, desired objectives, or any other appropriate information. Other informational sources may also be available corresponding to a job applicant such as past/present job applications, interviews and other feedback, performance evaluations, and/or other suitable information.

To aid in evaluating job applicants, a system 110 for evaluating information extracted from the pool of applicant data 120 may be implemented where historical resumes 114 and past performance data 116 are used in a computer system 112 that undergoes a selection process 150, where applicants are evaluated from the applicant data pool 120, which incorporates applicant information from a number of job applicants 126A, . . . , 126N. In this respect, the computer system 112 assesses whether or not job applicants are likely to exhibit future success at the particular job for which the company may be evaluating the applicant. Decisions may be made automatically or by people within the human resources function, with predictive assessments in mind, whether or not to interview particular applicants. Interviews may be conducted in any suitable manner, such as, for example, over the phone or in person and the additional feature data may be added to database 120.

In other aspects of the present invention, a historical database may be provided to serve as a standard for which future interview selections and/or hiring may be based. The historical database may include information of existing or past employees and/or job applicants, including any relevant job applicant information, as described above, along with historical data related to their performance since being hired or applying for a job. In addition, the historical database may also include information for those applicants that had been selected for interview but may or may not have been hired as an employee. In this regard, interview feedback information as well as whether or not the applicant was offered a position may be included along with the original job applicant information for the applicant. In addition, for applicants that have been hired as an employee, the historical database may also include information concerning the tenure of the employee at the company, for example, the types of positions that have been held, what activities that the employee was involved in, the level of success that the employee may have attained, or any other pertinent information. The historical database will generally include relevant information that could aid in identifying indicators for future success by a potential job applicant and may be used for developing predictors that would be intimately involved in selecting job applicants for actual interview. In various embodiments, the historical database may include information normally maintained by a human resources function within an enterprise.

In further aspects of the present invention, as shown in FIG. 1, a computer system 112 extracts information from the applicant information in the applicant database 120 that aids in determining future performance likelihood of the corresponding applicants, based on historical data. In some embodiments, the computer system 112 may extract values associated with classifying features that indicate items within applicant information corresponding to a number of applicants 126A, . . . , 126N, and determine, based on historical resumes 114 and performance data 116, which applicants may have a score relating to high probability for future success. It may then be determined that applicants that have high future success scores may be brought in for an actual interview 130 at the discretion of human resources personnel. It should be understood that the evaluation step 130 is optional and is not a requirement for the present invention.

As described herein in one non-limiting example for how applicants may be evaluated, items within applicant information, for example resumes, may be identified based on classifying features and values may be associated with the features, the values of items then being used to evaluate specific applicants. As a specific example, a feature “GPA” may be used to identify a specific value on a resume such as “3.2” or a feature “Schools Attended” may be used to identify a value “Stanford.” Features may also be generated based on entity extraction algorithms. In one example, extracting a feature such as GPA may be connected to other features such as the school, attendance, and/or degree granted. In other instances, certain features may or may not be closely tied to other features that may be related.

Once the optional interview 130 is completed, a subsequent evaluation 140 may optionally be provided. In this respect, the interviewer 142 may record feedback information on the results of the interview by inputting into a system 144. Alternatively, the interviewer 142 may record interview feedback information in any number of suitable ways such as, but not limited to, writing a personal note, recording an audio monologue, or any other appropriate manner. In addition, interview information recorded from the interviewer 142 may be added to the performance database 116 and correlated with the resume submitted by the interviewed job applicant, which may be stored in historical resumes database 114 for reference in developing predictors for future success, so that applicants may be selected for interview. It should be understood that the evaluation step 140 is optional and is not a requirement for the present invention.

Once the interview is completed, a decision may be made as to whether or not the interviewee will be hired. Hiring decisions, in general, are made with input from appropriate recruiting personnel. In the scenario illustrated in FIG. 1, applicant 126B is given an offer and is subsequently hired, after which performance reviews 160 may be used and added to the performance database 116 and correlated with a resume or other applicant information stored in historical resumes database 114 for reference to predictor development in future interview selections based on indications of future job success.

In other aspects of the present invention, information may be extracted from applicant information 124A, . . . , 124N, corresponding to particular job applicants 126A, . . . , 126N, based on historical data that correlates particular features, and the values associated with the features, to indications of future success and/or failure. In addition, predictors may be developed in scoring applicants according to the extracted features their associated values based on what historical performance data has shown. Predictors may also be tested based on their ability to accurately score applicants.

In different aspects of the present invention, based on historical data, certain aspects of applicant information may be identified as strong indicators for whether or not an applicant may perform well in the future. In this respect, features may be generated that are aimed at capturing aspects of applicant information that serve as strong performance indicators. In addition, certain algorithms with which various predictors operate may be more effective in scoring actual applicants than others. In some embodiments, selected features and predictors are evaluated in combination for predicting future success in job applicants. In other embodiments, selected features and predictors are evaluated independently for predicting future success in job applicants.

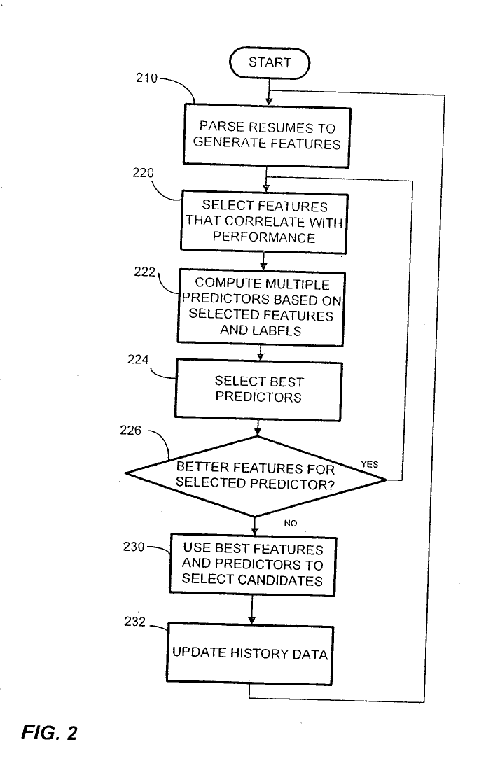

FIG. 2 depicts an embodiment in the form of a process flowchart for extracting features, selecting features, and selecting predictors based on prediction accuracy of job applicants. In this case, processing at block 210 begins with resumes of job applicants taken from the historical resumes database 114. Resumes may be analyzed through a parsing process 210 where features may be identified by a human or by a machine that looks for recurring patterns that could serve as a feature for an item. As described previously, examples of features may be in the form of text strings such as “GPA,” “major,” “previous experience,” etc. Extraction of features may be performed in any suitable manner, such as, for example, through any suitable string analysis for text resumes.

Once features are extracted from resumes and generated into the system 110, particular features may then be selected that correlate best with future performance 220. In this regard, selection of features may be done by correlating historical resumes 114 and performance data 116 and may be assigned particular degrees of importance. For example, if applicants that were hired happened to have a high GPA have consistently performed well, then a feature for GPA would likely be selected as an indicator for future success. This correlation may be performed using a known machine learning tool, such as a tool that performs a cluster analysis. However, any suitable mechanism may be used to identify suitable features.

After determining which features are to be selected, a plurality of predictors may be computed based on the selected features 222. In this process block 222, predictors may be developed from a variety of machine learning algorithms using the selected features and labeled employees to eventually determine which applicants may perform well based on historical data. In this regard, different predictors may use different training and processing algorithms for evaluating selected features corresponding to specific applicant information.

Next, based on the features selected at block 220, the most accurate predictor may be selected at block 224. The selection of a predictor may be done through any suitable validation and testing method. As one example, each of the predictors may be applied to the same validation data set and the chosen predictor's accuracy verified using a labeled test set of employee data. In this respect, labels may be used to assign known success levels to sets of employee data based on evaluations of performance.

In other aspects of the present invention, selection of the most appropriate predictors and features may be an iterative process where predictors are under a continuous optimization scheme. For example, an inquiry may be made at block 226 of whether or not better features exist to better evaluate applicants with the predictor selected at block 224. If the result of the inquiry is yes, as in, better features do exist for selected predictors, then the process may be directed back to the step of selecting features that correlate with performance 220. In this regard, the selection of features and predictors for ultimately producing an optimal combination may be iteratively performed.

If the result of the inquiry for whether or not there are better features for use by the selected predictor is no, as in, there is no knowledge of features for the selected predictor that are better than the ones that are used presently, then the next process block 230 may be performed where the best features are used for the selected predictor in selecting applicants for potential interview. In this regard, useful features are selected with a useful predictor for scoring applicants and developed based on historical performance data. Applicants with the highest probability scores for future success may then be grouped together and further evaluated for further action, such as whether they will be interviewed. Applicants with lower probability scores for future success will likely not receive an invitation for interview. Though, an organization may take any suitable action based on results of a predictor developed in this fashion.

Once applicants are interviewed and/or hired, then history data may be updated 232 accordingly so that future selection of features and predictors may be further refined. In the example presented herein, historical data update 232 involves correlating historical resumes 114 to performance data 116 either from the interview itself or aspects of job performance. From an updated history database, the selection of features and predictors may be refined. The process may begin anew for another pool of job applicants.

In another aspect of the present invention, the manner in which features are generated and selected to correlate with performance may be explored. Generally, as particular aspects of applicant information may correlate well with future success, the selection process may vary depending on different parameters, such as for example, whether the applicant information is presented in text form, audio/video presentation, relevant third party conversation, and/or other suitable source. In various embodiments, extraction, generating, and selection of features may be performed in an automated fashion and/or manually.

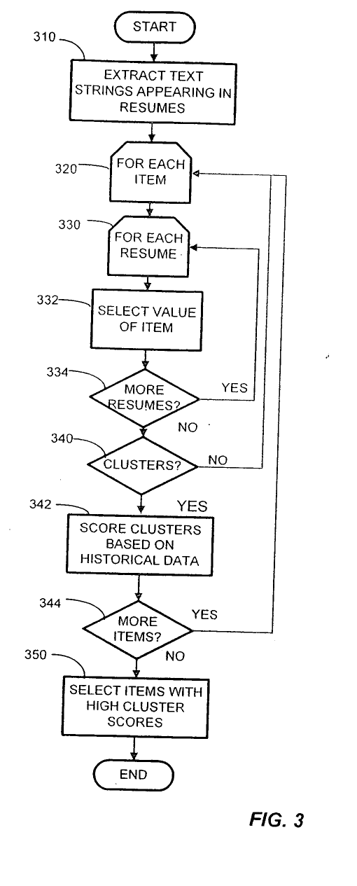

FIG. 3 depicts one embodiment of a process where features are selected from a pool of applicant resumes and values are extracted for particular items based on those features on resumes and eventually identified as to whether there may be a correlation of that particular item to performance success based on historical data. In this regard, at the beginning, as items on resumes are commonly in the form of text, though are not required to be as they could be formatted as images or in other suitable formats, text strings within resumes may be extracted as features 310. Extraction of features from resumes may occur in any suitable fashion as items may be formatted in different ways. In some embodiments, features in the form of text strings may be extracted along with surrounding text that may serve as value indicators for the particular features. Surrounding text may be considered to be a number of possibilities, including text immediately surrounding the text features, text that completes the line format that the feature may be contained within, and/or text that may be contained within certain formats, such as returns, periods, tabs, large spacing, or any other appropriate separating text.

Herein, features may be extracted for each item 320 and for each resume 330 as part of analyzing a pool of resumes in the historical resumes database 114. The value of each feature from each item may then be selected 332. As a non-limiting example, an item may appear on a resume in the form of a text string such as “GPA on a 4.0 scale is 3.5.” In the example of an item presented, the feature extracted would be “GPA” and the value would be 3.5 of 4.0. As described, such a parsing and valuing 332 procedure could be performed for every item 320 on every resume 330 for each corresponding applicant.

Once the value of each item is selected, an inquiry may be performed as to whether or not there are more resumes to be analyzed 334. If the answer to the inquiry is yes, then more resumes may be analyzed going back to extracting items for each resume 330.

Moving on in FIG. 3, if there are no more resumes to be considered, then broader inquiries may be made to identify features associated with items that are useful indicators of future performance. One such inquiry may be whether or not there are any detectable trends or clusters 340 in the feature values that correlate to performance. Typically, in larger job applicant resume pools, assuming a reasonable distribution with relatively little bias, clusters of values may exist for various features. In this regard, if the answer to the inquiry of whether or not correlation clusters exist for an item is no, then more analysis may be performed for another item 320. If for an item there indeed is a suitable number of clusters or trends that correlate with performance, then the clusters may be scored based on historical data 342 to produce a score indicating how good an indicator of future performance the item is. In this respect, historical resumes 114 and past performance data 116 may be significant in correlating features with actual levels of performance from past applicants. It can be appreciated that for different embodiments, various types of feature and value cluster correlations may exist. Clusters of features and values may be scored according to any suitable fashion in relation to historical data.

Once clusters of values are scored based on historical data 342, another inquiry may be made for whether or not there are more items to be analyzed 344. If the answer to the inquiry is yes, then process flow may loop back to more features and items extracted from resumes that may be analyzed 320 and the iteration process may continue as before, adding to the number of items scored for predictive capabilities. If a sufficient number of items are analyzed, then items with features associated with high cluster scores may be selected at block 350. In this respect, items corresponding to features with high values that are positively correlated with high levels of success based on past performance data are chosen from resumes of corresponding job applicants and may be used for a predictor in evaluating particular applicants.

In other aspects of the present invention, various predictors may be developed and tested according to how accurate their predictions of future success may be. In this respect, machine learning algorithms could be used to drive different predictors. In some embodiments, historical performance data may be used to develop predictors. In other embodiments, validation data independent from the performance data set may be used to test predictors.

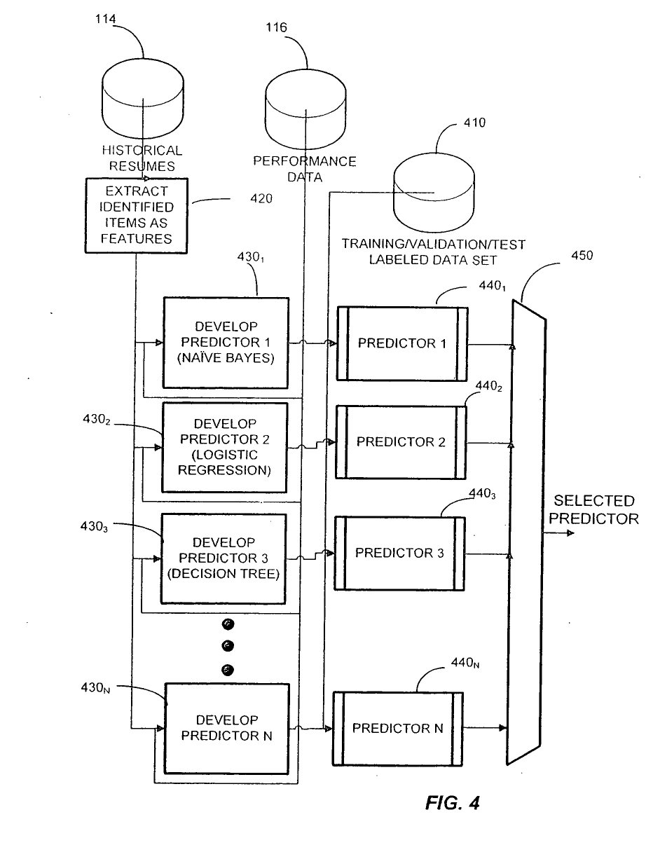

FIG. 4 shows one embodiment where various predictors corresponding to different machine learning algorithms may be created according to historical resumes 114, performance data 116, and then subsequently evaluated based on an independent validation set 410. In general, past historical information may be extracted and used to develop predictors that utilize various machine learning algorithms, where eventually one predictor may be used for actually selecting applicants for potential interview based on prediction of future performance success. Supervised learning algorithms using sets of labeled employee training data as well as unsupervised learning algorithms using sets of both labeled employee and unlabeled applicant data may be employed. In this regard, labeled employee performance data may be used for training, validating, and testing learning in predictor algorithms.

As depicted, items of historical resumes are extracted 420, based on features and corresponding values. Performance data 116 related to each of the historical resumes 114 are used alongside the extracted data to develop predictors with different machine learning algorithms 430₁, 430₂, 430₃, . . . , 430_{N}. In various embodiments, examples of machine learning algorithms may include, but are not limited to, Naïve Bayes 430₁, Logistic Regression 430₂, decision trees 430₃, linear or quadratic Support Vector Machines, k-mean, and/or any other suitable algorithm.

As an example of one way to create a predictor, weights may be assigned to particular classifier features extracted from applicant information by the machine learning algorithm in determining whether or not certain features are important indicators for future employment success. In certain embodiments, the machine learning algorithm may be supervised with checks in place in order to assess whether or not the algorithm would be able to accurately and efficiently select ideal applicants. In other embodiments, the machine learning algorithm may be unsupervised once operators of the system determine that the predictor used in the system for assessing applicant information accurately and efficiently, is suitably reliable.

Weights may be assigned to each classifier feature. It can be appreciated that certain employment positions will require certain skill sets more than others and that different predictors may be constructed for different positions. It can also be appreciated that certain aspects of a job applicant's experience will be more indicative of the applicant having a suitably matching skill set than other aspects. In this regard, particular items of a resume may be weighted more than other elements by different predictors. For example, in a software engineering position, more significance may be placed on technical skills/knowledge and programming experience. As a result, for this non-limiting example, more weight may be placed on aspects of a applicant resume that may have majored in computer science with a high technical GPA and/or having an internship at a related software company.

Regardless of how predictors are developed, once predictors are developed, correlating features of resumes to actual performance data, each predictor 440₁, 440₂, 440₃, . . . , 440_{N} may be evaluated to determine which predictor most accurately predicts future success of individuals, based on a validation set 410 that is independent from the historical data used to create the predictor. In the example shown, the historical data includes data from historical resumes 114 and performance data 116. Once a predictor is developed based on a machine leaning algorithm, an independent validation set may be used to determine whether or not the predictor is suitably accurate based on the scores that are assigned to individuals and how well they actually performed. Comparisons may be made between different machine learning algorithms with the same validation set.

Once predictors are independently assessed as to accuracy, efficiency, or any other appropriate factor, a predictor may be selected 450 and used to score and select individual applicants out of a pool of applicants to be potentially brought in for interview based on likelihood for future success.

As mentioned previously, while the selected predictors assesses the likelihood that an applicant would be successful upon hiring, the decision on if an applicant will be interviewed would typically be made at the discretion of recruiting personnel within the human resources function of the company. In an example, the cost of covering the expense of traveling may play into whether or not a particular applicant may be invited to interview, comparing a different applicant who may have the same skill set, yet does not require significant travel expense. In this regard, more consideration may be placed on applicants who are local to the hiring company. It should be understood that some aspects may be weighted more greatly than other aspects. With regard to the example given, if an applicant who may be considered for a software engineering position needs to travel a significant distance for an interview, yet has a skill set that is extremely well qualified for the position, then it may be beneficial for the company to cover the expense of travel for the applicant.

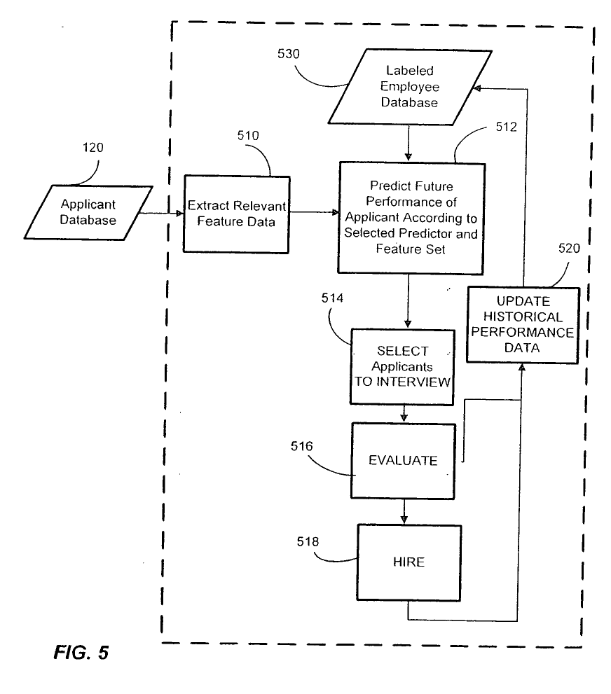

FIG. 5 depicts an overarching scheme for a human resources hiring process with aspects of the system from the present invention in mind. In various aspects, applicants assessed as to whether they will achieve future success if hired based on predictor selection from historical data that may be continuously updated, and may or may not subsequently be chosen to interview. As shown, an applicant database 120 may be provided with an assortment of job applicant information. The applicant database 120 may be fed into the hiring system where first, relevant data may be extracted 510 according to aspects presented herein.

Relevant data may then be assessed by a selected predictor which assesses future performance of individual applicants 512 according to particular indicators that may be present in the relevant data extracted from the corresponding resumes. Based on the predictions made by the predictor on future levels of success, applicants may be selected for interview 514 by recruiting personnel. Once the interview occurs, individual applicants may be evaluated 516 and decisions may be made on whether or not offers will be made to the applicants. Because of errors that may be inherent in the feature extraction and machine learning scoring algorithms, it should be understood that the evaluation 516 and decisions for offer are made with an appropriate amount of human input. If applicants who are offered positions accept, then they are hired 518 and every relevant review of performance may be used to update historical data 520. As described previously, historical data may be updated not only by performance reviews of hires, but also evaluations from interviews, and/or any other suitable method of determining level of success. In this respect, historical data may be updated into a featured and classified employee database 530 where predictors and the predictions that are made may be further refined for future hiring endeavors. In addition, applicant and employee data privacy and security during data process, scoring, and evaluation is maintained.

In other aspects of the present invention, after each predictor is developed from relevant performance data, a validation test set may be used to check accuracy of prediction from the predictor and allow various features of the predictor functions to be fine tuned. In general, the larger the historical database of past performance data, the more potential for predictors to be accurate and useful in helping human resource personnel with recruiting tasks and determine feature priorities in applicants. In this respect, use of machine learning algorithms may allow for thousands of resumes with hundreds of features to be considered objectively within a short period of time. Furthermore, aspects of the present invention allow for a considerable amount of historical information that previously had not been used for recruiting and predicting purposes in an objective manner such as that presented herein.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other computer storage media) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as features to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. At least one computer readable media, comprising:
at least one data structure comprising:
an applicant database (120) comprising applicant information corresponding to individual job applicants (126A, . . . , 126N);
an employee database (114, 116) comprising employee information corresponding to current employee levels of performance (116);
computer-executable instructions that, when executed by a computer, control the computer to perform a process comprising acts of:
developing a predictor (112, 430, 440, 450) that predicts employee performance based on values of one or more items (124A, . . . , 124N, 128) of applicant information;
applying the predictor (512) to the applicant information in the applicant database to select one or more selected applicants; and
updating the predictor (520, 530) based on performance information obtained on at least a portion of the selected applicants following their selection.

2. The computer-readable media of claim 1, wherein the computer-executable instructions control a process further comprising acts of:
identifying the one or more items (124A, . . . , 124N) of applicant information based on a correlation between values (332) of the item and future performance.

3. The computer-readable media of claim 2, wherein identifying the one or more items of applicant information comprises identifying text strings acting as features (310) for items (128) in a resume (124A, . . . , 124N) and determining a degree to which values associated with the features correlate to performance (350).

4. The computer-readable media of claim 1, wherein developing a predictor (430) comprises:
developing a plurality of predictors (430₁, 430₂, 430₃, . . . , 430_{N});
assigning a score to each of the plurality of predictors by applying historical data to each of the plurality of predictors (440₁, 440₂, 440₃, . . . , 440_{N}); and
selecting a predictor (450) of the plurality of predictors based on the assigned scores.

5. The computer-readable media of claim 1, wherein developing a predictor (430) comprises:
training predictors based on item values and historical labeled data (520, 530);
identifying correlation clusters (342) between item values and the historical labeled data (520, 530); and
selecting a predictor (450) of the plurality of predictors based on the correlation clusters.

6. The computer-readable media of claim 1, wherein updating the predictor based on performance information obtained on at least a portion of the selected applicants following their selection comprises obtaining historical performance information (520) of previous hires from performance reviews (160).

7. The computer-readable media of claim 1, wherein updating the predictor based on performance information obtained on at least a portion of the selected applicants following their selection comprises obtaining historical performance information (520) of previous applicants from interviews (140).

8. A system for predicting future performance of one or more job applicants (126A, . . . , 126N) using machine learning algorithms comprising:
a computer storage medium comprising job applicant information corresponding to a job applicant;
an employee database (114, 116, 530) comprising employee information identifying current employee levels of performance for a plurality of current employees;
a predictor (112, 512) that predicts a future level of performance of the job applicant based on a plurality of items (128) appearing in the job applicant information; and
an updater (530) that updates the predictor based on information identifying the current employee levels of performance.

9. The system for predicting future performance of one or more job applicants of claim 8, further comprising a historical database (114, 116, 530) comprising performance data relating to past interviews (130, 140).

10. The system for predicting future performance of one or more job applicants of claim 9, wherein the predictor predicts future interview performance of the job applicant based on the plurality of items (128) appearing in the job applicant information.

11. The system for predicting future performance of one or more job applicants of claim 8, wherein the job applicant information comprises a resume (124A, . . . , 124N) of the individual job applicant (126A, . . . , 126N).

12. The system for predicting future performance of one or more job applicants of claim 8, wherein the job applicant information comprises items (128) that the predictor uses to assess future level of performance of the job applicant (126A, . . . , 126N).

13. The system for predicting future performance of one or more job applicants of claim 8, further comprising an extractor (510) that extracts and sorts job applicant information into a format that the predictor uses to predict future level of performance of the job applicant (126A, . . . , 126N).

14. A method of performing a human resources function using a data processing system, the method comprising:
extracting with the data processing system applicant information (128₁, 128₂, . . . ) from an applicant database (120) based on historical performance data of previous applicants, the historical performance data being stored in a historical database (114, 116, 530);
identifying applicants from the applicant database with a predictor, the predictor executing on the data processing system using the extracted applicant information and based on indicators of positive performance derived from information in the historical database;
selecting one or more identified applicants for interview;
evaluating applicants selected for interview (516); and
updating the historical database (520) based on the evaluating applicants selected for interview.

15. The method of performing a human resources function using a data processing system of claim 14, wherein extracting with the data processing system applicant information (128₁, 128₂, . . . ) from an applicant database (120) comprises extracting performance data from a computer-readable media.

16. The method of performing a human resources function using a data processing system of claim 15, wherein extracting performance data from a computer-readable media comprises automatically extracting performance data with computer-executable instructions.

17. The method of performing a human resources function using a data processing system of claim 14, wherein evaluating applicants selected for interview comprises evaluating hired employees (160).

18. The method of performing a human resources function using a data processing system of claim 14, wherein updating the historical database based on the evaluating applicants selected for interview comprises updating the historical database (520) from evaluating hired employees (160).

19. The method of performing a human resources function using a data processing system of claim 14, wherein identifying applicants from the applicant database with a predictor comprises developing the predictor from a plurality of predictors (430) based on ability evaluate future performance of job applicants independently of a validation set (410) of information and corresponding performance.

20. The method of performing a human resources function using a data processing system of claim 14, wherein:
extracting with the data processing system applicant information (128₁, 128₂, . . . ) from an applicant database (120) comprises extracting performance data from a computer-readable media automatically with computer-executable instructions;
identifying applicants from the applicant database with a predictor comprises developing the predictor from a plurality of predictors (430) based on ability evaluate future performance of job applicants independently of a validation set (410) of information and corresponding performance;
evaluating applicants selected for interview comprises evaluating hired employees (160); and
updating the historical database based on the evaluating applicants selected for interview comprises updating the historical database (520) from evaluating hired employees (160).
